SEQUENCE LISTING (6 sequences)

SEQ ID NO: 1 - DNA, 1731 bp, Artificial Sequence
  Synthetic spider silk protein
atggctagcatgactggtggacagcaaatgggtcgcggatccatgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggttctagcgcggctgcagccgcggcagctgcgtccggcccgggtggctacggtccggaaaaccagggtccatctggcccgggtggctacggtcctggcggtccgggctaa

SEQ ID NO: 2 - protein, 576 aa, Artificial Sequence
  Synthetic Construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 3 - DNA, 1683 bp, Artificial Sequence
  R16 Silk protein
atggctagcatgactggtggacagcaaatgggtcgcggatccatgggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggcccgggttctagcgcggctgcagccgcggcagctgcgtccggcccgggtcagggccagggtcagggtcaaggccagggtggccgtccttctgacacctacggctaa

SEQ ID NO: 4 - protein, 560 aa, Artificial Sequence
  Synthetic Construct
MASMTGGQQMGRGSMGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYGPGSSAAAAAAAASGPGQGQGQGQGQGGRPSDTYG

SEQ ID NO: 5 - DNA, 1923 bp, Artificial Sequence
  S16 Silk protein
atggctagcatgactggtggacagcaaatgggtcgcggatccatgggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggttctgcggctgcagccgcggcagctgcgggtccgggcggtggcaacggtggccgtccgtctgacacctacggtgcgccgggtggcggtaacggtggccgtccttcttcctcttacggctaa

SEQ ID NO: 6 - protein, 640 aa, Artificial Sequence
  Synthetic Construct
MASMTGGQQMGRGSMGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYGSAAAAAAAAGPGGGNGGRPSDTYGAPGGGNGGRPSSSYG

(19) United States
(12) Patent Application Publication
(10) Pub. No.: US 2012/0085262 A1
(43) Pub. Date: Apr. 12, 2012

(54) Production of Highly Concentrated Solutions of Self-Assembling Proteins

(75) Inventors: Evgueni Klimov, Ludwigshafen (DE); Burghard Liebmann, Bensheim (DE); Thomas Subkowski, Schriesheim (DE); Martin Möller, Aachen (DE); Doris Klee, Aachen (DE); Artem Davidenko, Aachen (DE); Wiebke Voigt, Mannheim (DE); Gunter Scharfenberger, Frankenthal (DE)

(73) Assignees: Freudenberg Forschungsdienste KG, Weinheim (DE); BASF SE, Ludwigshafen (DE)

(21) Appl. No.: 13/217,868

(22) Filed: Aug. 25, 2011

Related U.S. Application Data
(60) Provisional application No. 61/377,103, filed on Aug. 26, 2010.

(51) Int. Cl. C09D 189/00; B29C 47/00

(52) U.S. Cl. 106/158.1; 106/124.1; 264/465

(57) ABSTRACT

The present invention concerns stable aqueous protein dispersions comprising in an aqueous phase at least one self-assembling protein in dispersed form and also at least one specific dispersant for the self-assembling protein; processes for producing such stable aqueous dispersions; processes for electrospinning self-assembling proteins using such stable aqueous dispersions; processes for producing fibrous sheet bodies or fibers from such aqueous dispersions; the use of such aqueous dispersions for coating surfaces; the use of the materials produced by electrospinning in the manufacture of medical devices, hygiene articles and textiles; and also fibrous or fibrous sheet bodies produced by an electrospinning process of the present invention.

### RELATED APPLICATIONS

This application claims benefit (under 35 USC 119(e)) of U.S. Provisional Application 61/377,103, filed Aug. 26, 2010, which is hereby incorporated by reference.

The present invention concerns stable aqueous protein dispersions comprising in an aqueous phase at least one self-assembling protein in dispersed form and also at least one specific dispersant for the self-assembling protein; processes for producing such stable aqueous dispersions; processes for electrospinning self-assembling proteins using such stable aqueous dispersions; processes for producing fibrous sheet bodies or fibers from such aqueous dispersions; the use of such aqueous dispersions for coating surfaces; the use of the materials produced by electrospinning in the manufacture of medical devices, hygiene articles and textiles; and also fibrous or fibrous sheet bodies produced by an electrospinning process of the present invention.

### PRIOR ART

The electrospinning process is a preferred process for producing nano- and mesofibers. This process, described for example by D. H. Reneker, H. D. Chun in Nanotechn. 7 (1996), p. 216 et seq., typically comprises exposing a polymer melt or solution to a high electric field at an edge which serves as electrode. This can be achieved, for example, by extruding the polymer melt or solution in an electric field under low pressure through a cannula connected to one pole of a source of voltage. Owing to the resulting electrostatic charge on the polymer melt or solution, a stream of material will flow in the direction of the counter-electrode, only to solidify on its way to the counter-electrode. Depending on the electrode geometries, this process provides fibrous nonwoven webs, i.e., nonwovens, or ensembles of ordered fibers.

Natural starting materials, such as biopolymers or synthetic polymers derived therefrom are also processible by electrospinning.

An example is the processing of spider silk proteins of the spider Nephila clavipes from a hexafluoro-2-propanol solution into nanofibers by electrospinning, described by Zarkoob and Reneker (Polymer 45: 3973-3977, 2004). Attempts to spin Bombyx mori silk from a formic acid solution are described by Sukigara and Ko (Polymer 44: 5721-572, 2003), who varied the electrospinning parameters to influence the fiber morphology. Jin and Kaplan have reported water-based electrospinning of silk or silk/polyethylene oxide (Biomacromolecules 3: 1233-1239, 2002).

WO-A-03/060099 describes various methods (including electrospinning) and apparatuses for spinning Bombyx mori silk proteins and spider silk proteins. The spider silk proteins used were produced recombinantly by transgenic goats, recovered from their milk and subsequently spun.

Synthetic biopolymers constructed of repetition units of the insect protein resilin or of the spider silk protein known as R16 and S16 respectively are described in commonly assigned WO2008/155304. The polymers, which are in the form of microbeads, can for example be converted into gellike products or processed into protein films.

The electrospinning of polymers, for example synthetic biopolymers or other spinnable organic polymers, or mutually coordinated polymeric mixtures thereof, optionally in admixture with pharmaceutical or agrochemical actives is described in commonly assigned WO 2010/015709 and WO 2010/015419. Solutions of the polymers in organic solvents or concentrated formic acid are used as spinning solutions.

That aqueous solutions of R16 or S16 are spinnable in principle is mentioned in WO 2010/015419 in general terms. However, there is a fundamental problem with such aqueous solutions in that they lack stability, particularly at comparatively high protein concentrations, which leads to unwanted gelling or precipitation in the solution.

True, the solubility of such spinnable hydrophobic proteins can be greatly increased by means of known chaotropic reagents. The highest experimentally observed solubility in 10 M guanidinium thiocyanate (GdmSCN) solution is about 38%. When GdmSCN is removed again by dialysis, however, the protein precipitates.

### SUMMARY OF THE INVENTION

Owing to the poor solubility of highly hydrophobic proteins, such as the R16 protein for example, in water (max. about 1%), it is an object of the present invention to develop spinnable systems whereby the protein is stabilized at comparatively high concentrations in the liquid phase to be spun.

A first solution provided by the present invention to the problem of avoiding precipitation of the protein from the aqueous solution (during dialysis) comprises stabilizing the hydrophobic protein with a hydrophilic protein which likewise comprises hydrophobic moieties in its structure. More particularly, it was shown experimentally that bovine serum albumin (BSA, fraction V) meets these requirements. Bovine serum albumin is a soluble protein which performs a transporter function for fatty acids and lipids in blood. BSA consists of 607 amino acids and has a molecular mass of about 69.4 kDa. Fat-free BSA (ffBSA) is a particular embodiment of BSA, wherein there are additional hydrophobic sites through removal of fatty acids.

A second solution provided by the present invention to the above problem comprises stabilizing the hydrophobic protein with the aid of suitable protein fragments (peptides). The protein fragments of the present invention include hydrophilic as well as hydrophobic sequence domains. More particularly, two peptide-based systems are provided:
a) stabilizing the native R16 protein with the aid of protein fragments of the R16 protein,
b) stabilizing the native R16 protein with the aid of protein fragments of BSA.

The respective hydrolytic splitting of the protein to produce the stabilizing protein fragments is effected in a conventional manner, for example by means of an NaOH solution at 80° C.

A third solution provided by the present invention to the above problem comprising stabilizing the hydrophobic protein with the aid of suitable synthetic organic oligomers which are compounds known per se and are described for example in WO2010/057654, the disclosure of which is hereby expressly incorporated herein by reference. These oligomers likewise include hydrophilic as well as hydrophobic domains and stabilize the hydrophobic proteins in aqueous solutions at elevated concentrations.

The present inventor found more particularly that, surprisingly, all the various solution approaches described above provide stabilized aqueous protein dispersions keeping an elevated concentration of the hydrophobic protein stable for a period sufficient to further process such dispersions by electrospinning. This is a first in eliminating the need to use organic solvents or organic acids in high concentration in the electrospinning of hydrophobic polymers—greatly simplifying the overall process of producing nanofibers and fibrous sheet bodies and further reducing its costs. As a result, processes carried out according to the present invention are environmentally friendlier (because they spin from aqueous solution), gentler in the production of the fibers, and improve the stability of the proteins. In addition, the processes have the advantage of using smaller volumes and hence also superior handling. Because the protein solutions are concentrated, the fibers can be spun from aqueous solution with high throughput, i.e., high productivity.

### FIGURE DESCRIPTION

FIG. 1 shows the mass spectrum (Maldi-ToF) of an inventive R16 protein hydrolyzate.

FIG. 2 shows the mass spectrum (Maldi-ToF) of an inventive BSA protein hydrolyzate.

FIG. 3 shows electron micrographs of fibers obtained by electrospinning of R16 protein solutions stabilized with BSA and, for enhanced viscosity, additionally admixed with polyethylene oxide polymer (PEO); FIG. 3a shows the result of spinning a dispersion of R16 protein, BSA and PEO having respective solids contents of 42.5%, 42.5% and 15% for the components; FIG. 3b shows the result of a mixture of these three components, but at solids contents of 37%, 37% and 16%, respectively; and FIGS. 3c and d show the result of spinning a mixture of these three components having solids contents of 34.5%, 34.5% and 31%, respectively, at a spinning speed of 0.4 ml/h (FIG. 3c) and 0.5 ml/h (FIG. 3d).

FIG. 4 shows electron micrographs of fibers obtained by electrospinning an aqueous dispersion of R16 protein stabilized with the aid of peptide fragments of the R16 protein; FIG. 4a shows the spinning of a mixture of an R16 protein, R16 fragment and PEO having a solids content of 61%, 0.003% and 39%, respectively, for these components; and FIG. 4b shows the result of spinning these three components at respective solids contents of 74%, 0.004% and 26%.

FIG. 5 shows electron micrographs of fibers obtained by electrospinning an R16 protein solution stabilized with BSA peptide fragments. FIGS. 5a and b show the same fibers at different magnifications.

FIG. 6 shows an electron micrograph of fibers obtained by electrospinning of an R16 protein solution stabilized with an inventive amphiphilic oligomer of formula 1.

FIG. 7 shows the in vitro activity according to inventive R16 protein on the cell proliferation of fibroblasts. What is shown is the time-dependent change in the relative cell count at different concentrations of R16 protein fragments compared with the control (without such fragments).

### DETAILED DESCRIPTION OF THE INVENTION

### 1. Definition of General Terms

“Amphiphilic” describes the chemical property of a substance to be both hydrophilic and lipophilic. The hei//de.wikipedia.org/wikpolaren L “LERLINK” ht and also in apolar Lkipedia.org/wiki/L % C3% B6sungses is based on the fact that the substance has both hydrophilic and hydrophobic domains.

“Chaotropic” is used to designate chemical substances, for example barium salts, guanidine hydrochloride, thiocyanates such as guanidinium thiocyanates, perchlorates, which dissolve ordered hydrogen bonds in water. By breaking hydrogen bonds, chaotropic substances disturb the structure of water and cause an increase in entropy. In the case of amino acids, they thereby ameliorate hydrophobic effects and have a denaturing effect on proteins, since it is the aggregating of the hydrophobic amino acids which is the driving force in protein folding.

A “dispersion” is a heterogeneous mixture of two or more chemical entities that scarcely dissolve in or chemically bind to each other, if at all. An aqueous protein dispersion is accordingly a mixture of an aqueous medium (the dispersion medium) and the solid protein (the disperse phase) and thus can also be referred to as “aqueous protein suspension”.

A “carrier polymer” is to be understood as meaning biopolymers and/or their admixtures, or else admixtures of one or more synthetic polymers and one or more biopolymers wherein the carrier polymer is able to enter into non-covalent interactions with the active/benefit agent or agents to be formulated, or of enclosing or adsorbing (carrying) particulate actives (disperse or crystalline).

Active or benefit agent is to be understood as referring to synthetic or natural, low molecular weight substances having hydrophilic, lipophilic or amphiphilic properties, which can find use in agrochemistry, pharmacy, cosmetics or the food and feed industry; moreover biological active macromolecules embeddable in or adsorbable to a fibrous sheet body of the present invention, for example peptides (such as oligopeptides having 2 to 10 amino acid residues and polypeptides having more than 10, for example 11 to 100, amino acid residues) and also enzymes and single- or double strand nucleic acid molecules (such as oligonucleotides having 2 to 50 nucleic acid residues and polynucleotides having more than 50 nucleic acid residues).

The term “fibrous sheet body” comprises in the present invention not only individual polymeric fibers but also the ordered or random single- or multi-ply aggregation of a multiplicity of such fibers, for example fiber webs or nonwovens.

Unless specifically indicated, molecular weight recitations for polymers are Mn or Mw values.

### 2. Specific Embodiments

The present invention provides more particularly the following embodiments:
1. A stable aqueous protein dispersion comprising in an aqueous phase at least one self-assembling protein, produced naturally, synthetically or recombinantly, in dispersed form and at least one dispersant for the self-assembling protein, wherein the dispersant is a polymeric dispersant selected from amphiphilic proteins or is an oligomeric dispersant selected from amphiphilic peptide fragments and/or amphiphilic organic oligomers.
2. The stable aqueous dispersion according to embodiment 1 wherein the self-assembling protein is a microbead-forming or intrinsically unfolded protein, more particularly a silk protein, such as a spider silk protein, or an insect protein (such as resilin) or a self-assembling analog derived from at least one of these proteins and having a sequence identity of at least about 60% (based on the starting protein(s)).
3. The stable aqueous dispersion according to embodiment 1 or 2 wherein the self-assembling protein is selected from
   a) R16 protein comprising an amino acid sequence as per SEQ ID NO: 4;
   b) S16 protein comprising an amino acid sequence as per SEQ ID NO: 6;
   c) spinnable analog proteins derived from these proteins and having a sequence identity of at least about 60%, for example around 70, 80, 90, 95, 96, 97, 98 or 99%, to SEQ ID NO: 4 or 6, (for example also by inserting or attaching oligo-amino acid blocks, such as oligo-arginine blocks (1-20 Arg)).
4. The stable aqueous dispersion according to any preceding embodiment wherein the amphiphilic peptide fragment comprises a fragment of a precursor protein.
5. The stable aqueous dispersion according to any preceding embodiment wherein the polymeric dispersant is an albumin, more particularly bovine serum albumin (BSA) or fat-free bovine serum albumin (ffBSA).
6. The stable aqueous dispersion according to embodiment 4 wherein the precursor protein is an albumin, more particularly bovine serum albumin (BSA) or fat-free bovine serum albumin (ffBSA).
7. The stable aqueous dispersion according to embodiment 4 wherein the amphiphilic peptide fragment is a peptide fragment of a self-assembling protein according to embodiment 2 or 3.
8. The stable aqueous dispersion according to embodiment 1 wherein the amphiphilic organic oligomer is a block co-oligomer comprising ether structural units and comprising at least one hydrophobic ether oligomer block (more particularly having at least one hydrophobic side group) and at least one hydrophilic ether oligomer block (more particularly having at least one hydrophilic side group). Each of the blocks is more particularly homogeneous, i.e. constructed from essentially identical monomer structural units.
9. The stable aqueous dispersion according to any preceding embodiment comprising at least one self-assembling protein in a proportion in the range from 1% to 40% by weight, more particularly 2% to 30%, 3% to 25%, or 5-20% by weight, based on the total weight of the stable dispersion, optionally together with 0.01% to 50% by weight, more particularly 0.05% to 30%, 0.08% to 20%, or 0.1% to 10% by weight of at least one further formulating or processing auxiliary.
10. The stable aqueous dispersion according to any preceding embodiment comprising self-assembling protein and dispersant in a relative weight proportion in the range from 0.1:1 to 1:0.001, or 0.2:1 to 1:0.05, or 0.5:1 to 1:0.2 or 0.7:1 to 1:0.5.
11. A process for producing a stable aqueous dispersion of at least one self-assembling protein according to any preceding embodiment, which process comprises self-assembling protein being dissolved in an aqueous medium comprising a solubilizer (chaotrope) and the resulting solution being dialyzed or ultrafiltered in the presence of dispersant to remove the solubilizer (chaotrope) from the self-assembling protein.
12. The process according to embodiment 11 wherein a mixture of self-assembling protein and polymeric dispersant is dissolved in the aqueous medium comprising the chaotrope and the chaotrope is removed from the self-assembling protein, more particularly by dialysis against chaotrope-free dialysis medium, to form the stable dispersion.
13. The process according to embodiment 11 wherein self-assembling protein is dissolved in the aqueous medium comprising the chaotrope and the chaotrope is removed from the self-assembling protein to form the stable dispersion by adding amphiphilic peptide fragment or synthetic amphiphilic oligomer before or during the removal of the chaotrope.
14. The process according to any one of embodiments 11 to 13 wherein the removing of the chaotrope is effected by dialysis, ultrafiltration and/or precipitation.
15. The process according to embodiment 13 wherein the removing of the chaotrope is effected by dialyzing against a dialysis medium (dialysis buffer) comprising at least one amphiphilic peptide fragment or at least one synthetic amphiphilic oligomer.
16. The process according to any one of embodiments 11 to 15 wherein the chaotrope-containing aqueous medium is exchanged for a buffered aqueous medium.
17. The process according to embodiment 16 wherein the buffered medium has a pH in the range from about 4 to 12 or 10 to 12 or about 11.5.
18. The process according to any one of embodiments 14 to 17 wherein the dialysis volume the volume of the aqueous medium to be dialyzed, comprising chaotrope and self-assembling protein, is at least 100 times, for example 200 times, 300 times, 500 times, or 1000 times, higher.
19. A process for electrospinning self-assembling protein, which process comprises electrospinning a stable aqueous dispersion according to any one of embodiments 1 to 10 or obtained according to any one of embodiments 11 to 18.
20. A process for producing a fibrous sheet body or fibers comprising at least one self-assembling protein, which process comprises electrospinning an aqueous dispersion according to any one of embodiments 1 to 10 or obtained according to any one of embodiments 11 to 18 to form a fibrous sheet body.
21. The process according to either of embodiments 19 and 20 wherein the dispersion to be spun comprises self-assembling protein in a proportion of 1% to 40% by weight, more particularly 2% to 30%, 3% to 25% or 5-20% by weight, based on the total weight of the stable dispersion.
22. The process according to any one of embodiments 19 to 21 wherein the dispersion before spinning is mixed with at least one further additive selected from
   a) viscosity-adjusting means, such as organic/synthetic or biopolymers soluble or dispersible in the dispersion;
   b) carrier-forming polymers;
   c) pharmacological, agrochemical, skin- or hair-cosmetic actives;
   d) medicaments, wound healing promoters;
   e) antimicrobials, antibacterials or antivirals.
23. The use of a stable aqueous dispersion according to any one of embodiments 1 to 10 for coating, more particularly spray or dip coating or coatings in sheet form, surfaces, more particularly nonwovens, fibers and foams.
24. The use of the materials obtained according to any one of embodiments 19 to 22 for products from the medical sector, more particularly wound contact materials, sutures, medical devices, implants, tissue engineering.
25. The use of the materials obtained according to any one of embodiments 19 to 22 in the manufacture of hygiene articles and textiles.
26. A fiber or fibrous sheet body obtained by a process according to any one of embodiments 20 to 22.

### 3. Further Embodifications of the Invention

### i) Self-Assembling Proteins

Particularly useful self-assembling proteins are silk proteins in particular. Silk proteins for the purposes of the present invention are hereinbelow silk proteins which comprise highly repetitive amino acid sequences and are stored in the animal in a liquid form and the secretion of which gives rise to fibers by shearing or spinning (Craig, C. L. (1997) Evolution of arthropod silks. Annu. Rev. Entomol. 42: 231-67).

Particularly suitable proteins of this kind are spider silk proteins which were originally isolated from spiders, as from the major ampullate gland of spiders, for example ADF3 and ADF4 from the major ampullate gland of Araneus diadematus (Guerette et al., Science 272, 5258:112-5 (1996)).

Similarly suitable proteins are natural or synthetic proteins which are derived from natural silk proteins and which have been produced heterologously in prokaryotic or eukaryotic expression systems using genetic-engineering methods. Nonlimiting examples of prokaryotic expression organisms are Escherichia coli, Bacillus subtilis, Bacillus megaterium, Corynebacterium glutamicum and others. Nonlimiting examples of eukaryotic expression organisms are yeasts, such as Saccharomyces cerevisiae, Pichia pastoris and others, filamentous fungi, such as Aspergillus niger, Aspergillus oryzae, Aspergillus nidulans, Trichoderma reesei, Acremonium chrysogenum and others, mammalian cells such as Hela cells, COS cells, CHO cells and others, insect cells such as Sf9 cells, MEL cells and others.

Synthetic proteins based on repetition units of natural silk proteins are also suitable. In addition to synthetic repetitive silk protein sequences, these may further comprise one or more natural nonrepetitive silk protein sequences (Winkler and Kaplan, J. Biotechnol. 74: 85-93 (2000)).

Among synthetic spider silk proteins, it is also possible to use synthetic spider silk proteins which are based on repetition units of natural spider silk proteins for the formulation of active agents by means of spinning processes. In addition to synthetic repetitive spider silk protein sequences, these may further comprise one or more natural nonrepetitive spider silk protein sequences.

Among synthetic spider silk proteins, the so-called C16 protein must be mentioned (Hümmerich et al., Biochemistry, 43(42)13604-13612 (2004)) as per SEQ ID NO: 2 and functional equivalents, functional derivatives and salts of this sequence (cf. also WO2007/082936).

Preference is further given to synthetic proteins based on repetition units of natural silk proteins combined with sequences of insect structural proteins such as resilin (Elvin et al., 2005, Nature 437: 999-1002). Among these combination proteins formed from silk proteins and resilins, the R16 and S16 proteins should be mentioned in particular. These proteins have the polypeptide sequences shown in SEQ ID NO: 4 and SEQ ID NO: 6 (cf. WO2008/155304).

In addition to the polypeptide sequences shown in SEQ ID NO: 2, 4 and 6, particularly functional equivalents, functional derivatives and salts of these sequences are also preferred.

By “functional equivalents” are herein also meant in particular mutants which in at least one sequence position of the abovementioned amino acid sequences have an amino acid other than that specifically mentioned which nonetheless has the property for packing effect substances. “Functional equivalents” thus comprise the mutants obtainable by one or more amino acid additions, substitutions, deletions and/or inversions, and the recited changes can take place in any sequence position provided they lead to a mutant having the property profile which is in accordance with the present invention. Functional equivalence exists particularly even when there is qualitative agreement in reaction pattern between a mutant and an unmodified polypeptide.

“Functional equivalents” in the above sense also include “precursors” of the polypeptides described and also “functional derivatives” and “salts” of the polypeptides.

“Precursors” are natural or synthetic precursors of the polypeptides with or without the desired biological activity.

Examples of suitable amino acid substitutions are apparent from the table which follows:

| Original residue | Examples of substitution |
|---|---|
| Ala | Ser |
| Arg | Lys |
| Asn | Gln; His |
| Asp | Glu |
| Cys | Ser |
| Gln | Asn |
| Glu | Asp |
| Gly | Pro |
| His | Asn; Gln |
| Ile | Leu; Val |
| Leu | Ile; Val |
| Lys | Arg; Gln; Glu |
| Met | Leu; Ile |
| Phe | Met; Leu; Tyr |
| Ser | Thr |
| Thr | Ser |
| Trp | Tyr |
| Tyr | Trp; Phe |
| Val | Ile; Leu |

The term “salts” is to be understood as meaning not only salts of carboxyl groups but also acid addition salts of amino groups of the protein molecules of the present invention. Salts of carboxyl groups are obtainable in a conventional manner and comprise inorganic salts, for example sodium, calcium, ammonium, iron and zinc salts, and also salts with organic bases, for example amines, such as triethanolamine, arginine, lysine, piperidine and the like. Acid addition salts, for example salts with mineral acids, such as hydrochloric acid or sulfuric acid and salts with organic acids, such as acetic acid and oxalic acid likewise form part of the subject matter of the present invention.

“Functional derivatives” of polypeptides of the present invention are likewise preparable on functional amino acid side groups or on the N- or C-terminal end thereof by means of known techniques. Such derivatives comprise for example aliphatic esters of carboxylic acid groups, amides of carboxylic acid groups, obtainable by reaction with ammonia or with a primary or secondary amine; N-acyl derivatives of free amino groups, prepared by reaction with acyl groups; or O-acyl derivatives of free hydroxyl groups, prepared by reaction with acyl groups.

Also encompassed according to the present invention as “functional equivalents” are homologs to the proteins/polypeptides concretely disclosed herein. These have at least 60%, for example 70%, 80% or 85%, for example 90%, 91%, 92%, 93%, 94%, 95%, 96%, 97%, 98% or 99%, identity to one of the amino acid sequences concretely disclosed.

By “identity” between two sequences is meant particularly the identity of the residues over the entire sequence length in each case, in particular the identity calculated by comparison with the aid of the Vector NTI Suite 7.1 (Vector NTI Advance 10.3.0, Invitrogen Corp.) (or software from Informax (USA) using the Clustal method (Higgins D G, Sharp P M. Fast and sensitive multiple sequence alignments on a microcomputer. Comput Appl. Biosci. 1989 April; 5(2):151-1) setting the following parameters:

### Multiple Alignment Parameter:

| | |
|---|---|
| Gap opening penalty | 10 |
| Gap extension penalty | 0.05 |
| Gap separation penalty range | 8 |
| Gap separation penalty | off |
| % identity for alignment delay | 40 |
| Residue specific gaps | off |
| Hydrophilic residue gap | off |
| Transition weighing | 0 |

### Pairwise Alignment Parameter:

| FAST algorithm | off |
|---|---|
| K-tuple size | 1 |
| Gap penalty | 3 |
| Window size | 5 |
| M/50289 | |
| Number of best diagonals | 5 |

### ii) Dispersants

Stable aqueous dispersions are produced using polymer or oligomeric dispersants in particular.

(1) Polymeric dispersants are more particularly selected from among globulins, particularly albumins, more particularly bovine serum albumin (BSA) and fat-free preparations thereof (ffBSA), and are commercially available as such.

Albumins have a molar mass of about 66 000 Da and consist of 584 to 590 amino acids. Owing to their high proportion of cysteine, albumins have relatively high sulfur content. Albumins are water soluble, and their binding capacity for water is about 18 ml/g. Their isoelectric point is pH 4.6. Albumins are ampholytes, i.e., they can reversibly bind both anions and cations.

(2) Oligomeric dispersants are more particularly amphiphilic peptide fragments of the above-described natural and synthetic silk proteins and more particularly of R16 and S16 proteins; and also amphiphilic peptide fragments of the recited globulins, more particularly albumins, in particular BAS or ffBSA.

Fragments of this type are obtainable through controlled splitting of the starting proteins. For controlled splitting, for example, a suitable amount of the protein can be weighed into a test tube and be admixed with 0.2 M NaOH solution. The test tube is firmly sealed and the mixture is heated in a water bath to an internal temperature of about 80° C. The mixture thus obtained is vigorously stirred. After some time, the protein starts to dissolve in the NaOH solution. As soon as the protein has dissolved, the sample is taken from the water bath and cooled down and analyzed. The protein hydrolyzate obtainable in this way constitutes a mixture of peptide fragments having a molecular weight in the range from about 500 to 5000, for example 1000 to 3000 or 600 to 4000, as is readily verifiable by mass spectrometry (Maldi-ToF for example).

(3) Oligomeric dispersants are more particularly block co-oligomer comprising ether structural units and comprising at least one hydrophobic ether oligomer block (having at least one hydrophobic side group in particular) and at least one hydrophilic ether oligomer block (having at least one hydrophilic side group in particular) as obtainable as per WO2010/057654. More particularly, every one of the blocks has a homogeneous construction, i.e., is constructed of essentially identical monomeric structural units.

A specific group of block co-oligomer can be represented by the following general formula (A)

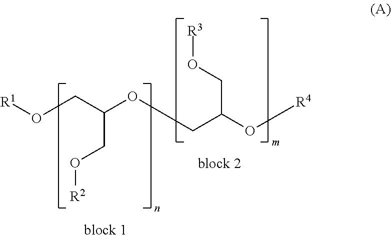

where:
n and m are the same or different and each represents integer values from 1 to 20, more particularly 3 to 10, such as 4, 5, 6, 7, 8 or 9,
the blocks 1 and 2 are different and one of the blocks 1 and 2 has hydrophilic side groups and the other has hydrophobic side groups,
R¹ represents H or straight-chain or branched C₁-C₆-alkyl, aryl or straight-chain or branched C₁-C₆-alkylaryl, where aryl is optionally substituted, and more particularly represents straight-chain or branched C₁-C₄-alkyl or straight-chain or branched C₁-C₄-alkylphenyl;
the side group radicals R² and R³ are different and are selected from hydrophobic radicals, more particularly straight-chain or branched C₁-C₆-alkyl, aryl or straight-chain or branched C₁-C₆-alkylaryl; or are selected from H and hydrophilic radicals, such as —(CH₂)ₚ—COOH, —(CH₂)ₚ—COO⁻ X⁺, where X⁺ represents H⁺ or a metal cation, such as an alkali metal cation, more particularly Na⁺ or K⁺ and p represents an integer value such as 1, 2 or 3;
but within the blocks 1 and 2 the side group radicals R² and R³, respectively, are the same, or within the blocks 1 and/or 2 the side group radicals R² and/or R³, respectively, can be different and form within a hydrophilic or hydrophobic block at least two different hydrophilic or, respectively, hydrophobic sub-blocks wherein each sub-block has at least 2 to 5 identical side group radicals; and
R⁴ represents H or C₁-C₆ alkyl, more particularly H.

C₁-C₆-Alkyl represents for example methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethyl-butyl, 3,3-dimethylbutyl, 1-ethylbutyl, 2-ethylbutyl, 1,1,2-trimethylpropyl, 1,2,2-trimethyl-propyl, 1-ethyl-1-methylpropyl and 1-ethyl-2-methylpropyl.

Aryl represents more particularly naphthyl or phenyl.

C₁-C₆-Alkylaryl represents more particularly the aryl- specifically phenyl-substituted analogs of the above C₁-C₆-alkyl radicals, more particularly of unbranched C₁-C₆-alkyl radicals.

Aryl substituents are more particularly C₁-C₄-alkyl radicals as per the above definition.

By way of preferred examples of such oligomers there may be mentioned compounds of the following formulae (1) to (5):

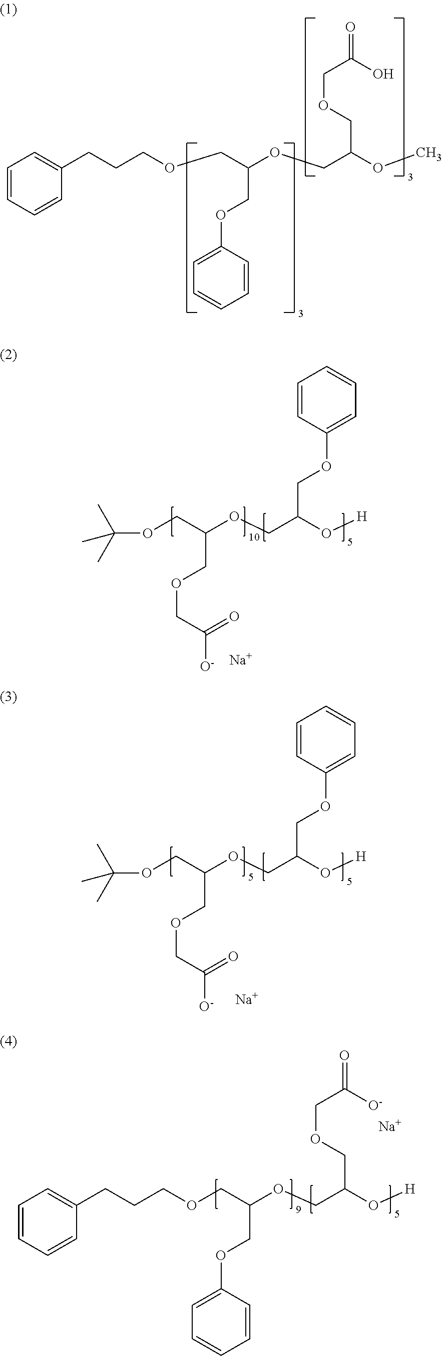

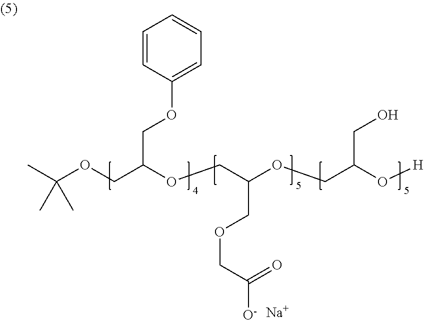

iii) Viscosity Increasers

To better process stabilized aqueous protein dispersions according to the present invention in electrospinning, it can be advantageous to admix a viscosity enhancer to this dispersion.

In principle, the stabilized protein solution/dispersion in an aqueous medium can be admixed with any water-soluble polymer known among those skilled in the art to be useful for the above purpose. Suitable polymers are more particularly: polyvinyl alcohol, polyvinyl formamide, polyvinylamine, polycarboxylic acid (polyacrylic acid, polymethacrylic acid), polyacrylamide, polyitaconic acid, poly(2-hydroxyethyl acrylate), poly(N-isopropylacrylamide), polymethacrylamide, polyalkylene oxides, e.g., polyethylene oxides; poly-N-vinylpyrrolidone; hydroxymethylcellulose; hydroxyethyl-cellulose; hydroxypropylcellulose; carboxymethylcellulose; alginate; collagen; gelatin, poly(ethyleneimine), polystyrenesulfonic acid; combinations of two or more of the aforementioned polymers; copolymers comprising one or more of the monomer units forming the aforementioned polymers, graft copolymers comprising one or more of the monomer units forming the aforementioned polymers.

In one specific embodiment of the present invention, the water-soluble polymer is selected from polyethylene oxide, polyvinyl alcohol, polyvinyl formamide, polyvinylamine and poly-N-vinylpyrrolidone.

The molar mass of the polymers used here can vary within wide limits, ranging for example from 500 to 2 000 000 or from 1000 to 1 000 000 or from 10 000 to 500 000.

The aforementioned water-soluble polymers are commercially available and/or obtainable by methods known to a person skilled in the art.

In the further embodiment of the present invention, the protein solution or dispersion to be used in the process of the present invention comprises from 0.01% to 40% by weight, such as 0.5% to 20% by weight or 2% to 15% by weight, of at least one water-soluble polymer as per the above definition, based on the total solids of the solution/dispersion.

The weight ratio of protein to the water-soluble polymer present in the solution or dispersion depends on the polymers used. For example, the protein and the water-soluble polymer used can be used in a weight ratio ranging from about 300:1 to about 1:5, for example from about 100:1 to about 1:2, or from about 20:1 to about 1:1.

### iv) Carrier-Forming Polymers

Suitable synthetic polymers are for example selected from the group consisting of homo- and copolymers of aromatic vinyl compounds, homo- and copolymers of acryl acrylates, homo- and copolymers of alkyl methacrylates, homo- and copolymers of α-olefins, homo- and copolymers of aliphatic dienes, homo- and copolymers of vinyl halides, homo- and copolymers of vinyl acetates, homo- and copolymers of acrylonitriles, homo- and copolymers of urethanes, homo- and copolymers of vinylamides and copolymers constructed of two or more of the monomeric units forming the aforementioned polymers.

Useful carrier polymers include more particularly polymers based on the following monomers:

acrylamide, adipic acid, allyl methacrylate, alpha-methylstyrene, butadiene, butanediol, butanediol dimethacrylate, butanediol divinyl ether, butanediol dimethacrylate, butanediol monoacrylate, butanediol monomethacrylate, butanediol monovinyl ether, butyl acrylate, butyl methacrylate, cyclohexyl vinyl ether, diethylene glycol divinyl ether, diethylene glycol monovinyl ether, ethyl acrylate, ethyldiglycol acrylate, ethylene, ethylene glycol butyl vinyl ether, ethylene glycol dimethacrylate, ethylene glycol divinyl ether, ethylhexyl acrylate, ethylhexyl methacrylate, ethyl methacrylate, ethyl vinyl ether, glycidyl methacrylate, hexanediol divinyl ether, hexanediol monovinyl ether, isobutene, isobutyl acrylate, isobutyl methacrylate, isoprene, isopropylacrylamide, methyl acrylate, methylenebisacrylamide, methyl methacrylate, methyl vinyl ether, n-butyl vinyl ether, N-methyl-N-vinylacetamide, N-vinylcaprolactam, N-vinylimidazole, N-vinylpiperidone, N-vinylpyrrolidone, octadecyl vinyl ether, phenoxyethyl acrylate, polytetrahydrofuran 2 divinyl ether, propylene, styrene, terephthalic acid, tert-butylacrylamide, tert-butyl acrylate, tert-butyl methacrylate, tetraethylene glycol divinyl ether, triethylene glycol dimethyl acrylate, triethylene glycol divinyl ether, triethylene glycol divinyl methyl ether, trimethylolpropane trimethacrylates, trimethylolpropane trivinyl ether, vinyl 2-ethylhexyl ether, vinyl 4-tert-butylbenzoate, vinyl acetate, vinyl chloride, vinyl dodecyl ether, vinylidene chloride, vinyl isobutyl ether, vinyl isopropyl ether, vinyl propyl ether and vinyl tert-butyl ether.

The term “synthetic polymers” comprises both homopolymers and copolymers. As copolymers, not only random but also alternating systems, block copolymers or graft copolymers are possible. The term copolymers comprises polymers which are constructed from two or more different monomers, or else where the incorporation of at least one monomer into the polymer chain can be realized in various ways, as is the case with stereoblock copolymers for example.

It is also possible to use admixtures of homo- and copolymers. The homo- and copolymers may or may not be miscible with each other.

The following polymers are preferably mentioned:

polyvinyl ethers such as, for example, polybenzyloxyethylene, polyvinyl acetals, polyvinyl esters such as, for example, polyvinyl acetate, polyoxytetramethylene, polyamides, polycarbonates, polyesters, polysiloxanes, polyurethanes, poly-acrylamides, for example poly(N-isopropylacrylamide), polymethacrylamides, poly-hydroxybutyrates, polyvinyl alcohols, acetylated polyvinyl alcohols, polyvinylformamide, polyvinylamines, polycarboxylic acids (polyacrylic acid, polymethacrylic acid), polyacrylamide, polyitaconic acid, poly(2-hydroxyethyl acrylate), poly(N-isopropylacryl-amide), polysulfonic acid (poly(2-acrylamido-2-methyl-1-propanesulfonic acid) or PAMPS), polymethacrylamide, polyalkylene oxides, e.g., polyethylene oxides; poly-N-vinylpyrrolidone; maleic acids, poly(ethyleneimine), polystyrenesulfonic acid, polyacrylates, e.g. polyphenoxyethyl acrylate, polymethyl acrylate, polyethyl acrylate, polydodecyl acrylate, poly(ibornyl acrylate), poly(n-butyl acrylate), poly(t-butyl acrylate), polycyclohexyl acrylate, poly(2-ethylhexyl acrylate), polyhydroxypropyl acrylate, polymethacrylates, e.g., polymethyl methacrylate, poly(n-amyl methacrylate), poly(n-butyl methacrylate), polyethyl methacrylate, poly(hydroxypropyl methacrylate), polycyclohexyl methacrylate, poly(2-ethylhexyl methacrylate), polylauryl methacrylate, poly(t-butyl methacrylate), polybenzyl methacrylate, poly(ibornyl methacrylate), polyglycidyl methacrylate and polystearyl methacrylate, polystyrene, and also copolymers based on styrene, for example with maleic anhydride, styrene-butadiene copolymers, methyl methacrylate-styrene copolymers, N-vinylpyrrolidone copolymers, polycaprolactones, polycaprolactams, poly(N-vinylcaprolactam).

Poly-N-vinylpyrrolidone, polymethyl methacrylate, acrylate-styrene copolymers, polyvinyl alcohol, polyvinyl acetate, polyamide and polyester are suitable in particular.

It is further possible to use synthetic biodegradable polymers.

The recitation “biodegradable polymers” shall comprise all polymers that meet the biodegradability definition given in draft DIN V 54900, more particularly compostable polyesters.

The general meaning of biodegradability is that the polymers, such as polyesters for example, decompose within an appropriate and verifiable interval. Degradation may be effected hydrolytically and/or oxidatively and predominantly through the action of microorganisms, such as bacteria, yeasts, fungi and algae. Biodegradability can be quantified, for example, by polyesters being mixed with compost and stored for a certain time. According to ASTM D 5338, ASTM D 6400 and DIN V 54900 CO₂-free air is flowed through ripened compost during composting and the ripened compost subjected to a defined temperature program. Biodegradability here is defined via the ratio of the net CO₂ released by the sample (after deduction of the CO₂ released by the compost without sample) to the maximum amount of CO₂ releasable by the sample (reckoned from the carbon content of the sample), as a percentage degree of biodegradation. Biodegradable polyesters typically show clear signs of degradation, such as fungal growth, cracking and holing, after just a few days of composting. Examples of biodegradable polymers are biodegradable polyesters such as, for example, polylactide, polycaprolactone, polyalkylene adipate terephthalates, polyhydroxyalkanoates (polyhydroxybutyrate) and polylactide glycoside. Particular preference is given to biodegradable polyalkylene adipate terephthalates, preferably polybutylene adipate terephtalates. Suitable polyalkylene adipate terephthalates are described for example in DE 4 440 858 (and are commercially available, e.g., Ecoflex® from BASF).

### v) Active Agents

The stabilized protein dispersions produced according to the present invention can also be used to produce fibers comprising an active or benefit agent, or sheet bodies comprising such fibers, such as films or fibrous nonwoven webs.

The production of such formulations comprising an active or benefit agent is described more particularly in commonly assigned WO2010/015419, which hereby is expressly incorporated herein by reference.

A detailed listing of potentially suitable classes of active or benefit agents and a non-limiting listing of representative examples thereof is likewise described in WO2010/015419.

Hydrophilics as well as hydrophobics can be formulated in principle. Examples of formulatable classes of matter are: proteins, peptides, nucleic acids, mono-, di-, oligo- and polysaccharides, proteoglycans, lipids, organic polymers, low molecular weight synthetic or natural organics or inorganics or chemical elements, for example silver.

Such formulations are more particularly useful in cosmetics, human medicine and veterinary medicine, but also in the field of crop protection.

Specific nonlimiting examples of formulatable classes of matter are:

dyes, fatty acids, carotenoids, retinoids, vitamins, provitamins, antioxidants, lipoic acids, UV lightscreen filters, peroxide decomposers, as used in the field of cosmetics or medicine; and also derivatives and precursors thereof.

Active pharmaceutical ingredients for therapeutic or diagnostic purposes, for example anti-irritants, anti-inflammatories, vasoactives, infection inhibitors, anesthetizers, growth promoters; and derivatives and precursors thereof;

wound healing promoters; and also actives that have a positive effect on wound healing;
antimicrobial, antibacterial or antiviral actives;
antibodies, enzymes, peptides, nucleic acids, growth factors.

Crop protection actives, for example those having a herbicidal, insecticidal and/or fungicidal effect.

The invention will now be more particularly described with reference to the following nonlimiting illustrative embodiments:

### Experimental Part:

### General Methods:

### 1. Electrospinning:

The protein solution was spun with the aid of a nozzle-based electrospinning system (from Gimpel Ingenieur-Gesellschaft mbH www.gimpel.de). The high-voltage source used was a generator from Eltex, type KNH34/N2A of 0-30 kV, DC neg. The protein solution was extruded in an electric field under low pressure through a cannula connected to the pole of a voltage source. Owing to the electrostatic charge on the protein solution as a result of the electric field, a stream of material flowed in the direction of the counter-electrode, only to solidify on its way to the counter-electrode and become deposited in the form of thin fibers.

The following parameter settings were used:

relative humidity: 27%,
spinning temperature: 23° C.,
electric voltage: 20 kV,
electrode distance: 15-20 cm,
cannula diameter: 0.8 or 0.9 mm,
pumping speed: 0.2 to 0.5 ml/h.

The illustrative embodiments described can further be applied to roll-based electrospinning systems.

### 2. Chromatography-Mass Spectrometry

### MALDI-ToF Measurement of Peptides

Matrices: α-Cyano-4-hydroxycinnamic acid (CCA)
Sinapic acid (SA)

The two matrices were used as saturated solutions (20 mg/ml), dissolved in TA.

### Composition of TA Solution

| Substance | Volume | |
|---|---|---|
| Acetonitrile | 3.33 | ml |
| H₂O | 6.66 | ml |
| Trifluoroacetic acid | 10 | μl |

Preparation methods were not only the “cover method” but also the “mix method”. In the “mix method”, the sample dissolved in buffer was mixed 1:10 with matrix and a defined volume applied to the target. The dilution factor in the “mix method” was 10, while in the “cover method” dilution was 1:1.

The high salt content of the samples was reduced with the aid of a solid phase extraction. Zip-Tip pipette tips from Applied Biosystems having a C₁₈ coating were used. The Zip-Tip was washed with 0.1% trifluoroacetic acid in pure acetonitrile and with 0.1% TFA in 1:1 acetonitrile/water. This was followed by double equilibration with 0.1% TFA in water. The sample was dissolved in 10 μl of 0.1% TFA solution and repeatedly pipetted in and out through the Zip-Tip to bind the peptides to the resin. Thereafter, the tip was washed three times with a solution of 0.1% TFA and 5% methanol in water. The sample constituents were eluted off the Zip-Tip with 1.8 μl of matrix solution (matrix dissolved in 0.1% TFA 50% acetonitrile) and directly pipetted onto the MALDI-ToF-MS target.

### 3. Cellular Proliferation Test

The in vitro test was carried out with fibroblasts (HDFn, Invitrogen, No. C0045C).

The test is carried out in the following steps:
seeding 15 000 cells per well in a 6 well plate in medium (DMEM low glucose with 10% FCS and 1% penicillin/streptomycin)
after 4 hours (cells have all grown in this period) changing the medium to the medium with addition of varying concentrations of protein fragments (preparation see hereinbelow); 1 ml/well
after 24 h incubation in incubator at 37° C. and 5% CO₂ adding Alamarblue (from Invitrogen order No. DAL1100; 100 μl per ml of medium; corresponds to a dilution of 1:10) and further incubating in incubator for 2 hours
transferring 2×100 μl supernatant per well (=double determination) into a 96 well plate with F bottom and measurement on Optima fluorescence reader at 544 nm
repeating the measurement at the various measuring times and evaluating by means of Excel program

### Preparation of Protein Fragments for Proliferation Test:

300 mg of R16 protein (or other proteins) are weighed into a test tube and admixed with 9 ml of 0.2 M NaOH solution. The test tube is firmly sealed. The mixture in the test tube is heated to an internal temperature of about 80° C. The temperature of the water bath here should be at least 85° C. The mixture is vigorously stirred. After some time the protein dissolves to form a transparent solution (color change). As soon as the protein has dissolved, the sample is taken from the water bath and cooled down. Thereafter, the sample must not be exposed to any further heat treatment since the fragments could be further split as a result and complete splitting may occur in certain circumstances.

After cooling, the sample is dialyzed against distilled water (5 L). The dialysis is carried out with a dialysis membrane of regenerated cellulose having a molecular weight cutoff of 1000 Da (Carl-Roth, order number: 1967.1). During the dialysis the water is changed three times.

Thereafter, the sample is transferred into a plastic Petri dish (determine the weight beforehand) and completely dried at 37° C. After weight determination, the sample can be used for the cell test.

### Reference Example 1

### Production of R16 and S16 Spider Silk Protein

Spinnable R16 and S16 solutions were produced using respectively R16 and S16 protein microbeads. These can be prepared as described in WO 2008/155304.

### Reference Example 2

### Preparation of Synthetic Amphiphilic Oligomeric Dispersants

(1) Preparation of oligomer P(phenyl glycidyl ether)-block-P(carboxymethyl glycidyl ether)-(3,3)

The amphiphilic oligomer named P(phenyl glycidyl ether)-block-P(carboxymethyl glycidyl ether)-(3,3) of formula 1:

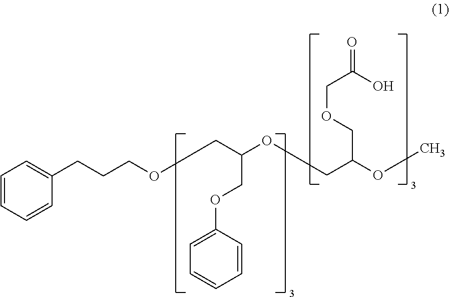

has three apolar phenyl ether groups and three polar carboxyl groups, which can become charged through pH changes of the solution, in its structure.

The syntheses were all carried out using customary Schlenk techniques and in the absence of oxygen/air.

### a) Synthesis of Ethoxyethyl Glycidyl Ether (EEGE) Monomer

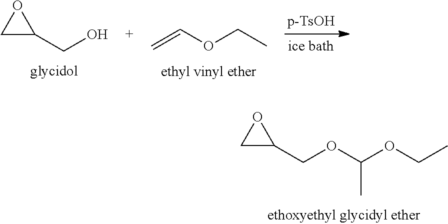

First, 80 g (1.08 mol) of glycidol and 400 mL of ethyl vinyl ether were admixed with 2 g of para-toluenesulfonic acid (p-TsOH) in an ice bath such that the temperature did not rise above room temperature. The batch was subsequently stirred for 3 h. Upon expiration of the reaction time the solution was washed three times with sodium bicarbonate and dried over sodium sulfate. The drier was filtered off and the solvent was removed in vacuo. The residue (about 250 mL of EEGE) was vacuum distilled (not higher than 70° C. oil bath temperature) and stored over calcium hydride. It was subsequently condensed over.

### b) Synthesis of First Oligomeric Intermediate

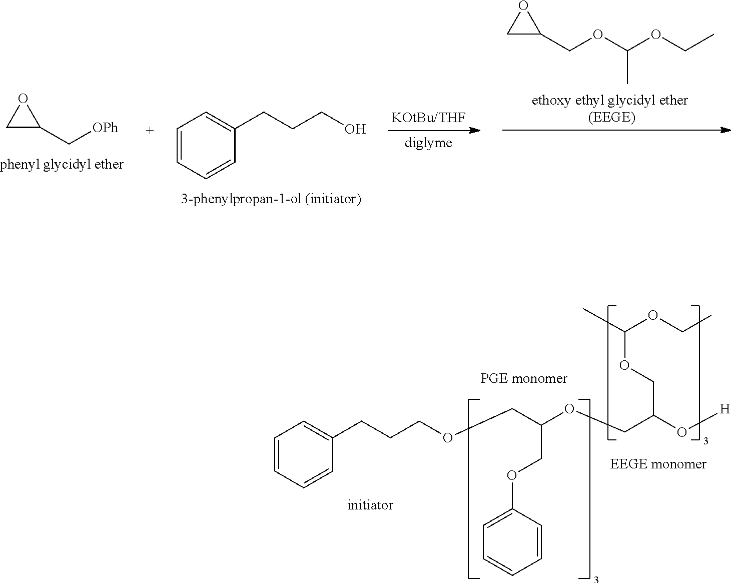

20.13 ml (0.148 mol) of the initiator 3-phenylpropan-1-ol were dissolved in 50 ml of diglyme with 14.8 ml (0.148 mol) of 10M potassium tert-butoxide. The solution was heated at 40° C. in vacuo for half an hour to remove tert-butanol. Then, 100 ml (0.739 mol) of previously purified PGE (condensed over and dried over CaH₂) were added to the initiator solution and stirred at 120° C. overnight. The next day, 98 ml (0.739 mol) of EEGE were added to the solution and the mixture was heated at 120° C. for 3 h with stirring. The diglyme was removed in vacuo to leave a golden brown honeylike liquid.

### c) Deprotecting the Oligomeric Intermediate

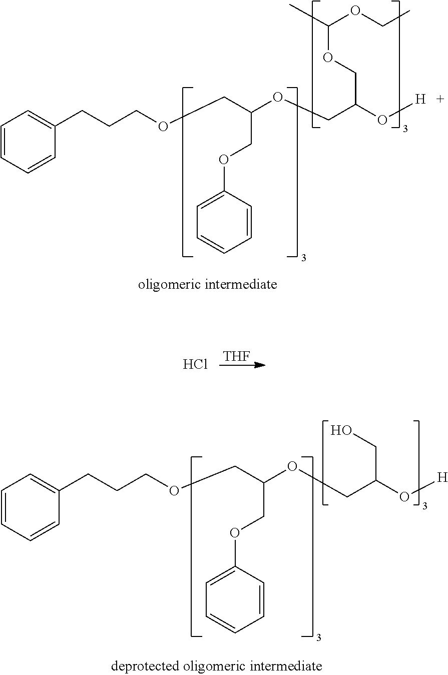

The golden brown honeylike liquid was dissolved in THF and admixed with 93 ml of conc. HCl (37%) and stirred for 1 h. Then, the solution was neutralized with NaHCO₃. A slightly brownish precipitate formed and was filtered off. Overnight, further precipitate came down. It was centrifuged off until all the solids had been removed from the solution. Then, the THF was removed in vacuo to leave 116.28 g (0.11 mol) of brownish, clear oil.

### d) Acetylation of Oligomeric Intermediate

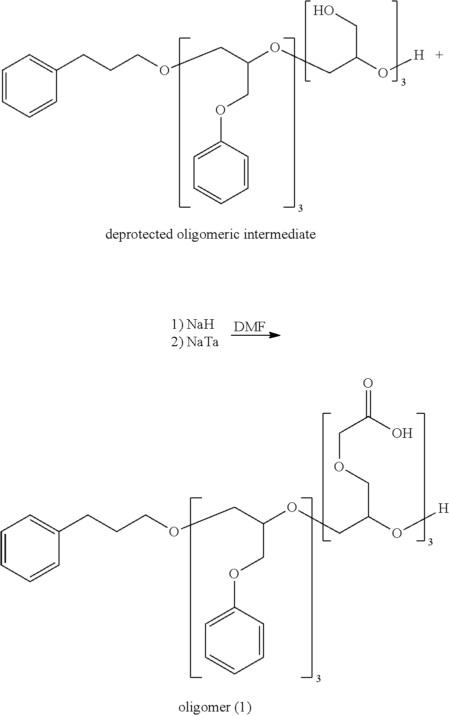

The brownish oil was dissolved in DMF and stirred with 16.2 g (0.45 mol) of NaH (washed with pentane) overnight. In the process, the solution turns dark brown. Then, 78.8 g (0.45 mol) of sodium chloroacetate (NaTa) were added and the batch was stirred at 60° C. overnight. The DMF was removed in vacuo and the residue was dissolved in distilled water. The product, a light brown precipitate, was brought down with half-concentrated HCl, separated off and thereafter redissolved in NaOH to obtain 127 g (0.127 mol) of P(phenyl glycidyl ether)-block-P(carboxymethyl glycidyl ether)-(3,3) of formula 1, which corresponds to a 52% yield of theory.

Dissolving in an NaOH solution gives a sodium salt instead of the acid function.

The product remains stable as sodium salt in solution for several months. The solution can also be dried at 37 degrees before use and stored as solid material.

### (2) Preparation of Further Oligomers

Repeating the above method of synthesis but varying the initiator, the molar fractions of the monomeric components and/or the degree of deprotection and acetylation it is possible to prepare, for example, the further amphiphilic oligomers of the formulae 2 to 5:

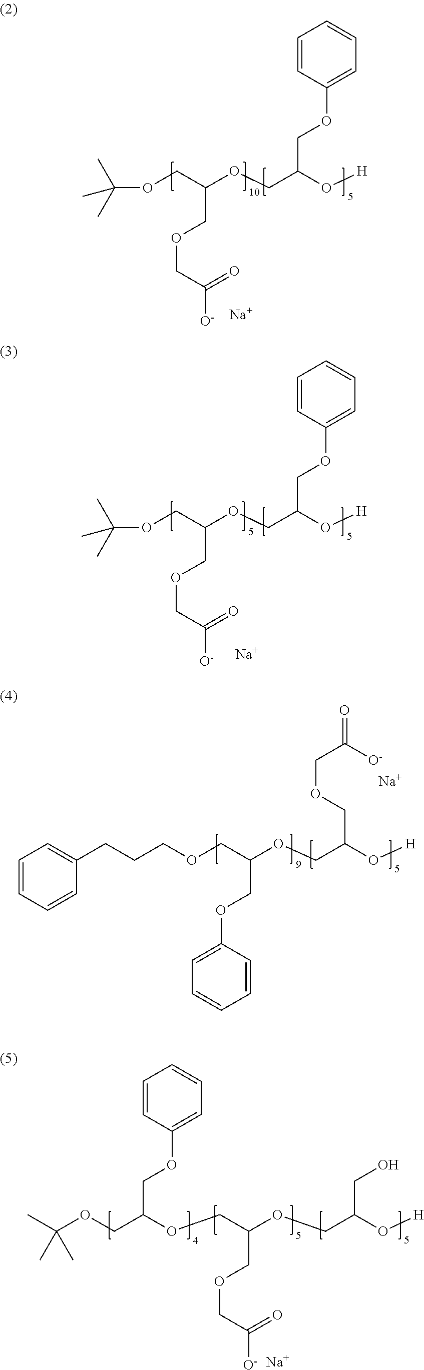

### Example 1

### Stabilizing R16 Spider Silk Protein Solutions with BSA and Spinning the Stabilized Product

### 1.1. Preparing Stabilized Solutions

Fat-free BSA (ffBSA) (Carl Roth GmbH & Co. KG, Karlsruhe) and R16 protein are weighed out, transferred into a snap top vial and dissolved with the aid of guanidine thiocyanate solution (6 M). A mixture of 140 mg of R16 protein and 140 mg of ffBSA can be dissolved in 2 ml of 6 M guanidine thiocyanate. The quantities of R16 and ffBSA used for various batches are shown in table 1.

The solution is stirred at room temperature (about 20-25° C.) overnight (for at least 12 h). Next the resulting ffBSA/R16 solution is dialyzed against 10 mM NaHCO₃ buffer (pH about 10.5). The dialysis takes place in a dialysis tube (Sigma-Aldrich, cat. No. D9777-100FT, cellulose membrane) having a molecular weight cutoff of about 12 400. The volume of the NaHCO₃ buffer is at least 100 times that of the sample. During dialysis, the buffer is changed at least once in order that the GdmSCN may be removed as quantitatively as possible.

The stability time of each solution during dialysis is determined and is likewise reported below in table 2. By stability is meant that during dialysis no gelling is observed in the particular solution.

### 1.2. Spinning the Stabilized Solution

To test the spinnability of the stabilized solutions 0.5 ml of the sample is spun with PEO polymer (polyethylene oxide, Mw=900 000; Sigma-Aldrich, cat. No. 189456-250g) in varying quantity. Various quantities of PEO (dissolved in water) are added, mixed in and spun in a laboratory electrospinning system under the conditions reported above.

The following solutions are spun, for example:

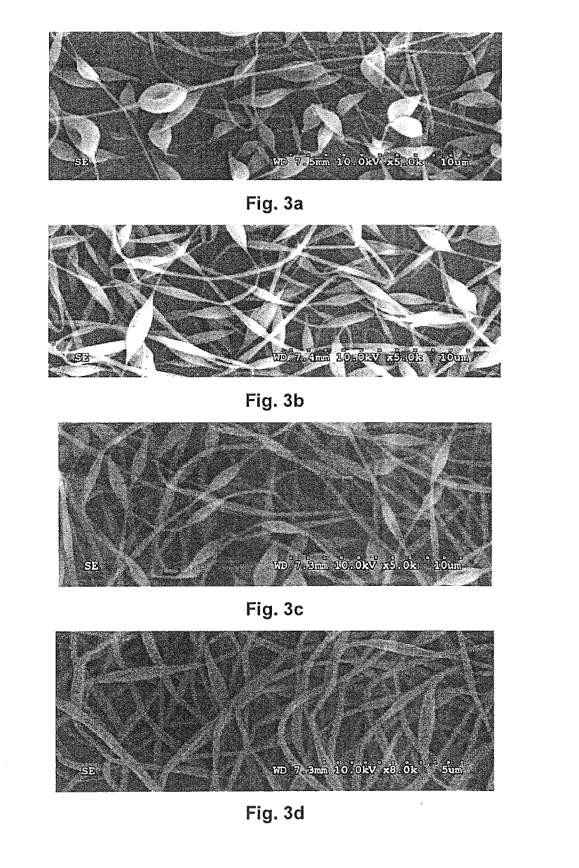

TABLE 1

| | | | Solids content | |
|---|---|---|---|---|
| | R16/ffBSA solution^{a)} | PEO (4%) | R16/ffBSA/PEO | |
| Sample | [ml] | [ml] | [%] | Depiction |
| A | 0.4 | 0.15 | 42.5/42.5/15 | FIG. 3a^{b)} |
| B | 0.5 | 0.3 | 37/37/16 | FIG. 3b^{b)} |
| C | 0.5 | 0.4 | 34.5/34.5/31 | FIG. 3c^{b)} |
| | | | | FIG. 3d^{c)} |

^{a)}7% each of R16 and ffBSA (batch No. 2, table 2)
^{b)}spinning at 0.4 ml/h
^{c)}spinning at 0.5 ml/h

Electron micrographs are shown in FIGS. 3a to d.

### 1.3. Results

TABLE 2

| Batch | R16 | ffBSA | Stability time | |
|---|---|---|---|---|
| No. | [%]^{a)} | [%]^{a)} | [h] | Comments |
| 1 | 5 | 5 | 7 | pH = 10 |
| | | | | spinnable |
| 2 | 7 | 7 | 6 | pH = 10 |
| | | | | spinnable |
| 3 | 9 | 9 | 6 | pH = 10-11 |
| | | | | spinnable |
| 4 | 11 | 11 | unstable | pH = 11 |
| | | | | gelled quickly |
| | | | | not spinnable |

^{a)}mass/volume (m/v)

It was determined that the best result can be achieved with a 1:1 mixture of ffBSA/R16.

### Example 2

### Stabilizing the R16 Spider Silk Protein with the Aid of Peptide Fragments of the R16 Protein and Spinning the Stabilized Product

### 2.1. Preparing the R16 Protein:

R16 protein is weighed out, transferred into a snap top vial and dissolved with the aid of guanidine thiocyanate solution (6 M).

### 2.2. Preparing the R16 Peptide Fragments:

45 mg of R16 protein are weighed into a test tube and 2 ml of 0.2 M NaOH solution are added. The test tube is firmly sealed and the mixture is heated in a water bath to an internal temperature of about 80° C. (the temperature of the water bath should be at least 85° C.). The resulting mixture is stirred vigorously (about 1000 rpm). After some time (about 10 min) the protein starts to dissolve in the NaOH solution. As soon as the protein has dissolved, the sample is taken out of the water bath and cooled. Thereafter the sample may no longer be exposed to an enhanced heat treatment since the fragments can be split further as a result and complete splitting may occur. Unsplit R16 protein is very clearly visible in the solution. During splitting, it begins to dissolve since the fragments are readily water-soluble. As soon as the protein can no longer be seen, splitting is terminated in order that complete hydrolysis may be avoided.

The R16 protein hydrolyzate prepared in this way constitutes a mixture of peptide fragments having a molecular weight in the range from about 1000 to 3000, as is illustrated by accompanying FIG. 1. It shows the mass spectrum (Maldi-ToF) of a typically generated R16 protein hydrolyzate.

### 2.3. Preparing the Dialysis Bath

After cooling, the hydrolyzate is transferred with a syringe into a dialysis bath (NaHCO₃ buffer) (10 mm, 1.5 l). The pH of the dialysis bath must be set to about 10-11 (NaOH, solid material). The R16 peptide quantity used for each of the various batches is listed in table 3 below.

### 2.4 Performing the Dialysis

Next R16 samples (prepared as per 2.1) having differing R16 protein content (cf. table 3) are dialyzed against the NaHCO₃ dialysis buffer (pH about 10.5) comprising the R16 hydrolyzate. To this end, the sample is transferred into a dialysis tube (Sigma-Aldrich, cat. No. D9777-100FT, cellulose membrane; molecular weight cutoff limit about 12 400). The volume (e.g., 1.5 liters) of the NaHCO₃ buffer should be at least 100 times that of the sample.

The stability time of each solution during dialysis is determined and is likewise reported below in table 3. By stability is meant that during dialysis no gelling is observed in the particular solution.

TABLE 3

| | | | | | R16 |
|---|---|---|---|---|---|
| | | R16 | | | fragment |
| | R16 protein^{a)} | fragment | Stability | pH of dialysis | in sample^{b)} |
| Batch No. | [%] | [g] | [h] | buffer | [%] |
| 1 | 5 | 0.045 | 9 | 10 | 0.003 |
| 2 | 7 | 0.045 | 9 | 10 | 0.003 |
| 3 | 7 | 0.060 | 6 | 10 | 0.004 |
| 4 | 9 | 0.060 | 7 | 10 | 0.004 |
| 5 | 11 | 0.060 | 6 | 10 | 0.006 |

^{a)}sample volume 2 ml in each case
^{b)}final concentration in sample after dialysis

### 2.5. Spinning the Stabilized Solution

To test the spinnability of the R16 fragment stabilized solutions 0.5 ml of the sample is spun with PEO polymer (polyethylene oxide, Mw=900 000; Sigma-Aldrich, cat. No. 189456-250g) in varying quantity. Various quantities of PEO (dissolved in water) are added, mixed in and spun in a laboratory electrospinning system under the conditions reported above.

The following solutions are spun, for example:

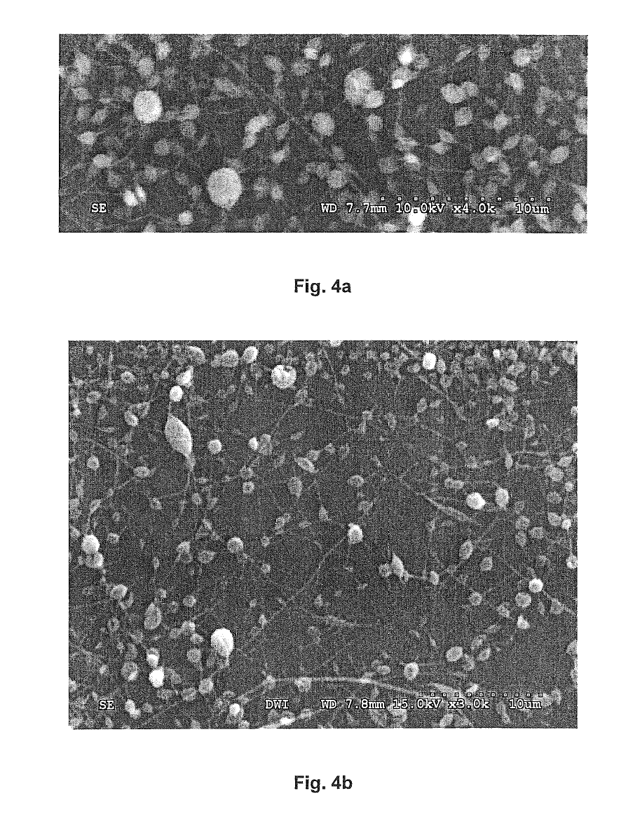

TABLE 4

| | | | Solids content of | |
|---|---|---|---|---|
| | R16/R16 fragment | | R16/R16 | |
| | solution^{a)} | PEO (4%) | fragment/PEO | |
| Sample | [ml] | [ml] | [%] | Depiction |
| A | 0.5 (5%) | 0.4 | 61/0.003/39 | FIG. 4a^{b)} |
| B | 0.5 (9%) | 0.4 | 74/0.004/26 | FIG. 4b^{c)} |

^{a)}% of R16 between parentheses
^{b)}spinning at 0.4 ml/h
^{c)}spinning at 20 cm, 15 kV, 0.3 ml/h

### Example 3

### Stabilizing the R16 Spider Silk Protein with the Aid of Peptide Fragments of BSA and Spinning the Stabilized Product

### 3.1. Preparing the R16 Protein:

R16 protein is weighed out, transferred into a snap top vial and dissolved with the aid of guanidine thiocyanate solution (6 M).

### 3.2. Preparing the BSA Peptide Fragments:

45 mg of BSA protein are weighed into a test tube and 2 ml of 0.2 M NaOH solution are added. The test tube is firmly sealed. The mixture in the test tube is dissolved at room temperature and then heated to an internal temperature of about 80° C. The temperature of the water bath should be at least 85° C. The mixture must be stirred vigorously (about 1000 rpm). After one minute the protein starts to split in NaOH solution to form a yellowish solution. As soon as the protein has split, the sample is removed from the water bath and cooled down. Thereafter the sample may no longer be exposed to an enhanced heat treatment since the fragments can be split further as a result and complete splitting may occur.

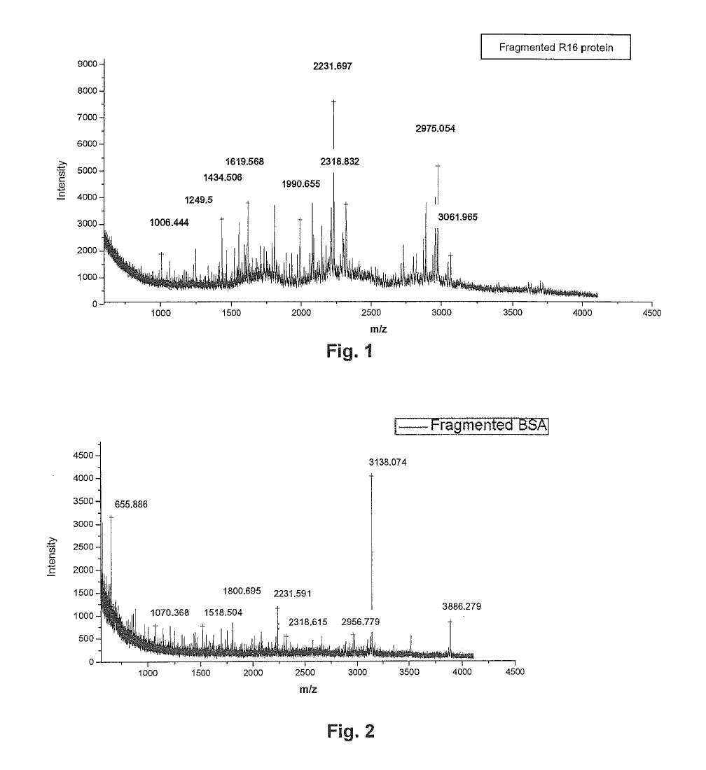

The BSA protein hydrolyzate prepared in this way constitutes a mixture of peptide fragments having a molecular weight in the range from about 600 to 4000, as is illustrated by accompanying FIG. 2. It shows the mass spectrum of a typically generated BSA protein hydrolyzate.

### 3.3. Preparing the Dialysis Bath:

After cooling, the sample is transferred with a syringe into the dialysis bath (NaHCO₃ buffer) (10 mm, 1.5 l). The pH of the dialysis bath must be set (with NaOH) to about 10-11. The BSA peptide concentration is about 0.003-0.004%.

### 3.4 Performing the Dialysis:

Next R16 samples (prepared as per 2.1) having differing R16 protein content, comprising the BSA hydrolyzate in differing amounts, (cf. table 5), are dialyzed. Dialysis takes place in a dialysis tube (Sigma-Aldrich, see above) having a molecular weight cutoff limit of about 12 400. The volume of the NaHCO₃ buffer should be at least 100 times (e.g., 2 ml of protein solution in a 1.5 l dialysis bath) that of the sample.

The stability time of each solution during dialysis is determined and is reported in table 5. By stability is meant that during dialysis no gelling is observed in the solution investigated.

TABLE 5

| | | BSA | | | BSA fragment |
|---|---|---|---|---|---|
| Batch | R16 protein^{a)} | fragment | Stability | pH of dialysis | in sample^{b)} |
| No. | [%] | [g] | [h] | buffer | [%] |
| 1 | 7 | 0.060 | 6 | 10 | 0.004 |
| 2 | 9 | 0.060 | 6 | 10 | 0.004 |
| 3 | 11 | 0.090 | 6 | 10 | 0.006 |

^{a)}sample volume 2 ml in each case
^{b)}final concentration in sample after dialysis

### 3.5. Spinning the Stabilized Solution

To test the spinnability of the BSA fragment stabilized solutions 2 ml of the sample are spun with PEO polymer (polyethylene oxide, Mw=900 000; Sigma-Aldrich, cat. No. 189456-250g) in varying quantity. Various quantities of PEO (PEO added as a solid, see table 6) are added, mixed in and spun in a laboratory electrospinning system under the conditions reported above.

The following solution is spun, for example:

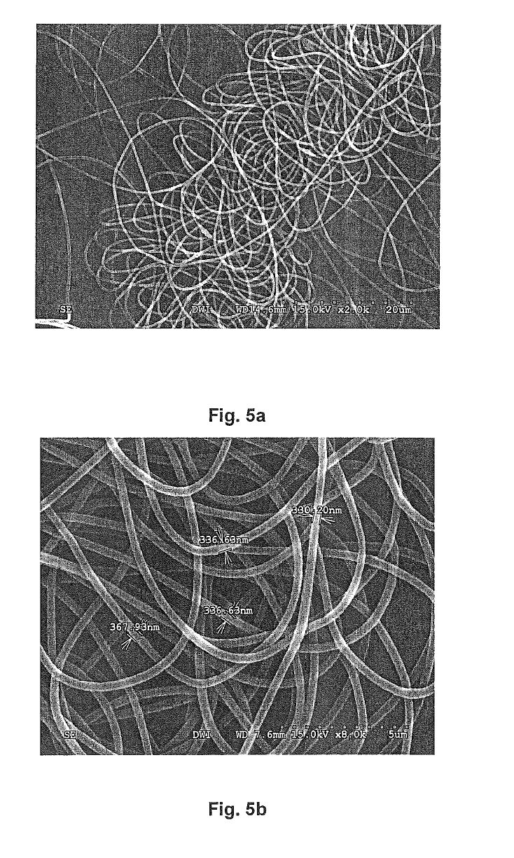

TABLE 6

| | | | Solids content of | |
|---|---|---|---|---|
| | R16/BSA fragment | | R16/R16 | |
| | solution | PEO (mg) | fragment/PEO | |
| Sample | [ml] | [solid] | [%] | Depiction |
| A | 2 ml | 40 mg | 78/0.004/22 | FIG. 5a, b^{a)} |
| | (7% R16) | (2%) | | |

^{a)}spinning at 20 kV, 15 cm, 0.2 ml/h

### Example 4

### Stabilizing the R16 Spider Silk Protein with the Aid of Synthetic Amphiphilic Oligomers and Spinning the Stabilized Product

The stabilizer used is P(phenyl glycidyl ether)-block-P(carboxymethyl glycidyl ether)-(3,3), prepared according to reference example 2(1).

The oligomer previously dissolved in NaOH solution, which in the form of the sodium salt remains stable in the solution for several months, can be used as a solution or as a solid (dried at 37° C.).

### 4.1 Preparing the R16 Protein:

To stabilize R16, the substance is used as a solid in particular. The R16 protein is dissolved in a 6M guanidine thiocyanate solution. The oligomer solid is weighed out and directly dissolved in the R16 solution. The solution is slowly stirred overnight. During this time, the oligomer adds onto the protein. Appropriate quantitative data for various batches are summarized below in table 7.

### 4.2 Performing the Dialysis:

The next day the dialysis is carried out to remove guanidine thiocyanate. The volume of the solution to be dialyzed is 3 ml (contains a magnetic stirbar and is stirred during the dialysis). The volume of the dialysis solution (10 mM NaHCO₃ buffer, pH=12 set with NaOH) is 1.5 l. The dialysis is run overnight (12 h).

The stability time of each solution during dialysis is determined and is reported below in table 7. By stability is meant that during dialysis no gelling is observed in the solution investigated.

TABLE 7

| | | | | pH of | Oligomer in |
|---|---|---|---|---|---|
| | R16 protein^{a)} | Oligomer | Stability | dialysis | sample^{b)} |
| Batch No. | [%, m/v] | [g] | [h] | buffer | [%] |
| 1 | 10 | 0.3 | at least 48 | 10.5 | 0.015 |
| | (5 ml) | | | | |
| 2 | 10 | 0.3 | at least 48 | 10.5 | 0.015 |
| | (7 ml) | | | | |
| 3 | 10 | 0.3 | at least 48 | 11 | 0.015 |
| | (10 ml) | | | | |
| 4 | 12 | 0.3 | at least 48 | 11 | 0.02 |
| | (5 ml) | | | | |
| 5 | 13 | 0.325 | at least 72 | 12 | 0.021 |
| | (5 ml) | | | | |
| 6 | 14 | 0.3 | at least 72 | 12 | 0.023 |
| | (5 ml) | | | | |

^{a)}sample volume between parentheses in each case
^{b)}final concentration in sample after dialysis

### 4.3 Spinning the Stabilized Solution

To test the spinnability of the oligomer-stabilized solutions 0.5 ml of the sample is spun with PEO polymer (polyethylene oxide Mw=900 000; Sigma-Aldrich, cat. No. 189456-250g). PEO (added as solid) is added, mixed in and spun in a laboratory electrospinning system under the conditions reported above.

The following solution is spun, for example:

TABLE 8

| | R16/oligomer | | Solids content of | |
|---|---|---|---|---|
| | solution | PEO (mg) | R16/oligomer/PEO | |
| Sample | [ml] | [solid] | [%] | Depiction |
| A | 71.5 ml | 1.43 g | 87.5/0.03/12.5 | FIG. 6^{a)} |
| | (14% R16) | (2%) | | |

^{a)}spinning at 20 kV, 15 cm, 0.2 ml/h

### Example 5

### Determining the Wound Healing Promoter Properties of an Inventive Fibrous Sheet Body

The wound healing promoter effect of the fibers produced according to the present invention (prepared as per example 2; R16 stabilized with R16 peptides) is determined by the cellular proliferation test described above.

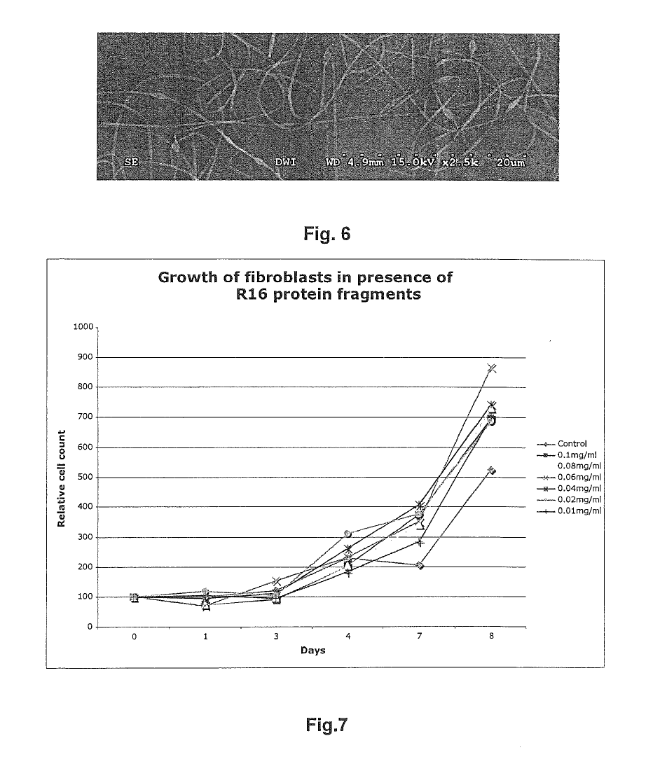

The experimental results are summarized in accompanying FIG. 7. The cell count is observed to increase over the period of 8 days. Adding R16 protein fragments results in an additional increase in the cell count (optimal concentration 0.06 mg/ml).

The disclosure of the printed publications mentioned herein, more particularly WO2010/057654, is expressly incorporated herein by reference.

1. A stable aqueous protein dispersion comprising in an aqueous phase at least one self-assembling protein in dispersed form and at least one dispersant for the self-assembling protein, wherein the dispersant is a polymeric dispersant selected from amphiphilic proteins or is an oligomeric dispersant selected from amphiphilic peptide fragments and amphiphilic organic oligomers.

2. The stable aqueous dispersion of claim 1, wherein the self-assembling protein is a microbead-forming or intrinsically unfolded protein, a silk protein, a spider silk protein, an insect protein, or a self-assembling analog derived from at least one of these proteins and having a sequence identity of at least about 60% to the protein from which it is derived.

3. The stable aqueous dispersion of claim 1, wherein the self-assembling protein is selected from
a) an R16 protein comprising the amino acid sequence of SEQ ID NO: 4;
b) an S16 protein comprising the amino acid sequence of SEQ ID NO: 6; or
c) a spinnable analog protein derived from the protein of a) or b) and having a sequence identity of at least about 60% to SEQ ID NO: 4 or 6.

4. The stable aqueous dispersion of claim 1, wherein the amphiphilic peptide fragment comprises a fragment of a precursor protein.

5. The stable aqueous dispersion of claim 1, wherein the polymeric dispersant is an albumin, a bovine serum albumin (BSA), or a fat-free bovine serum albumin (ffBSA).

6. The stable aqueous dispersion of claim 4, wherein the precursor protein is an albumin, bovine serum albumin (BSA), or fat-free bovine serum albumin (ffBSA).

7. The stable aqueous dispersion of claim 4, wherein the amphiphilic peptide fragment is a peptide fragment of a self-assembling protein, and wherein said self-assembling protein
(a) is a microbead-forming or intrinsically unfolded protein, a silk protein, a spider silk protein, an insect protein, or a self-assembling analog derived from at least one of these proteins and having a sequence identity of at least about 60% to the protein from which it is derived; or
(b) is selected from
i) an R16 protein comprising the amino acid sequence of SEQ ID NO: 4;
ii) an S16 protein comprising the amino acid sequence of SEQ ID NO: 6; or
iii) a spinnable analog protein derived from the protein of i) or ii) and having a sequence identity of at least about 60% to SEQ ID NO: 4 or 6.

8. The stable aqueous dispersion of claim 1, wherein the amphiphilic organic oligomer is a block co-oligomer comprising ether structural units and comprising at least one hydrophobic ether oligomer block (having hydrophobic side groups) and at least one hydrophilic ether oligomer block (having hydrophilic side groups).

9. The stable aqueous dispersion of claim 1, comprising at least one self-assembling protein in a proportion in the range from 1% to 40% by weight, based on the total weight of the stable dispersion, optionally together with 0.01% to 50% by weight of at least one further formulating or processing auxiliary.

10. The stable aqueous dispersion of claim 1 comprising the self-assembling protein and the dispersant in a relative weight proportion in the range from 0.1:1 to 1:0.001.

11. A process for producing the stable aqueous dispersion of claim 1, which process comprises
(a) dissolving the self-assembling protein in an aqueous medium comprising a solubilizer (chaotrope); and
(b) dialyzing or ultrafiltering the resulting solution in the presence of a dispersant to remove the solubilizer (chaotrope) from the self-assembling protein.

12. The process of claim 11, wherein a mixture of self-assembling protein and polymeric dispersant is dissolved in the aqueous medium comprising the chaotrope and the chaotrope is removed from the self-assembling protein by dialysis against chaotrope-free dialysis medium, to form the stable aqueous dispersion.

13. The process of claim 11, wherein the self-assembling protein is dissolved in the aqueous medium comprising the chaotrope and the chaotrope is removed from the self-assembling protein to form the stable dispersion by adding an amphiphilic peptide fragment or a synthetic amphiphilic oligomer before or during the removal of the chaotrope.

14. The process of claim 11, wherein the removing of the chaotrope is effected by dialysis, ultrafiltration, or precipitation.

15. The process of claim 13, wherein the removing of the chaotrope is effected by dialyzing against a dialysis medium (dialysis buffer) comprising at least one amphiphilic peptide fragment or at least one synthetic amphiphilic oligomer.

16. The process of claim 11, wherein the chaotrope-containing aqueous medium is exchanged for a buffered aqueous medium.

17. The process of claim 16, wherein the buffered medium has a pH in the range from about 10 to 12.

18. The process of claim 14, wherein the dialysis volume is at least 100 times higher than the volume of the aqueous medium to be dialyzed, comprising chaotrope and self-assembling protein.

19. A process for electrospinning a self-assembling protein, which process comprises electrospinning the stable aqueous dispersion of claim 1 or a stable aqueous dispersion obtained by a process for producing a stable aqueous dispersion of at least one self-assembling protein that is a microbead-forming or intrinsically unfolded protein, a silk protein, a spider silk protein, an insect protein, or a self-assembling analog derived from at least one of these proteins and having a sequence identity of at least about 60%, which process comprises self-assembling protein being dissolved in an aqueous medium comprising a solubilizer (chaotrope) and the resulting solution being dialyzed or ultrafiltered in the presence of dispersant to remove the solubilizer (chaotrope) from the self-assembling protein.

20. A process for producing a fibrous sheet body or fibers comprising at least one self-assembling protein, which process comprises
a) electrospinning the aqueous dispersion of claim 1 to form a fibrous sheet body; or
b) electrospinning a stable aqueous dispersion obtained by a process for producing a stable aqueous dispersion of at least one self-assembling protein that is a microbead-forming or intrinsically unfolded protein, a silk protein, a spider silk protein, an insect protein, or a self-assembling analog derived from at least one of these proteins and having a sequence identity of at least about 60% to the protein from which it is derived, which process comprises self-assembling protein being dissolved in an aqueous medium comprising a solubilizer (chaotrope) and the resulting solution being dialyzed or ultrafiltered in the presence of dispersant to remove the solubilizer (chaotrope) from the self-assembling protein, to form a fibrous sheet body.

21. The process of claim 19, wherein the dispersion to be spun comprises self-assembling protein in a proportion of 1% to 40% by weight based on the total weight of the stable dispersion.

22. The process of claim 19, wherein the dispersion before spinning is mixed with at least one further additive selected from
a) a viscosity-adjusting compound, an organic/synthetic or biopolymer soluble or dispersible in the dispersion;
b) a carrier-forming polymer; or
c) a pharmacological, agrochemical, skin- or hair-cosmetic active compound.

23. A method for coating a surface, a nonwoven, a fiber or a foam comprising coating a surface, nonwoven, fiber or foam with the stable aqueous protein dispersion of claim 1.

24. A method for the manufacture of a product for the medical sector, a wound contact material, a suture, a medical device, an implant, or tissue engineering comprising utilizing the material produced by the process of claim 19 for producing a product for the medical sector, a wound contact material, a suture, a medical device, an implant, or tissue engineering.

25. A method for the manufacture of a hygiene article or textile comprising utilizing the material obtained by the process of claim 19 in the production of a hygiene article or textile.

26. A fiber or fibrous sheet body obtained by the process of claim 20.
